(19) United States
(12) Patent Application Publication
(10) Pub. No.: US 2013/0044068 A1
(43) Pub. Date: Feb. 21, 2013

(54) TOUCH DISPLAY PANEL

(71) Applicants: Ta-Wei Yeh, Taichung City (TW); Chi-Ming Hsieh, Taichung City (TW); Jen-Wei Chou, Taichung City (TW); Chia-Chi Chen, Taichung City (TW); Hui-Chun Chen, Kaohsiung City (TW); Hong-En Yang, Taichung City (TW)

(72) Inventors: Ta-Wei Yeh, Taichung City (TW); Chi-Ming Hsieh, Taichung City (TW); Jen-Wei Chou, Taichung City (TW); Chia-Chi Chen, Taichung City (TW); Hui-Chun Chen, Kaohsiung City (TW); Hong-En Yang, Taichung City (TW)

(73) Assignees: WINTEK CORPORATION, Taichung City (TW); WINTEK (CHINA) TECHNOLOGY LTD., Guangdong Province (CN)

(21) Appl. No.: 13/587,934

(22) Filed: Aug. 17, 2012

(30) Foreign Application Priority Data
Aug. 17, 2011 (TW) 100129421

(51) Int. Cl. G06F 3/041

(52) U.S. Cl. 345/173

(57) ABSTRACT

A touch display panel including a display panel and a touch panel is provided. The display panel includes a shielding pattern and a plurality of pixels separated by the shielding pattern and including multiple edge directions. The touch panel is disposed on the display panel and includes a plurality of first sensing series, a plurality of second sensing series and a plurality of dielectric patterns. Each dielectric pattern is disposed between each first sensing series and each second sensing series intersected therewith, and includes multiple edge direction non-parallel to the edge direction of the pixel.

### CROSS-REFERENCE TO RELATED APPLICATION

This application claims the priority benefit of Taiwan application serial no. 100129421, filed on Aug. 17, 2011. The entirety of the above-mentioned patent application is hereby incorporated by reference herein and made a part of this specification.

### BACKGROUND OF THE INVENTION

1. Field of the Invention

The present invention generally relates to a touch display panel, and more particularly, to a touch display panel which can enhance the entire visual effect.

2. Description of Related Art

With the progress of electronic technology and the arrival of information era, many information products choose to use touch panels as the input device instead of the traditional input device such as keyboard, mouse, etc. The touch display panel with both touch sensing function and display function has become one of the most prevalent products on the current market.

In the conventional touch display panels, the touch-point circuit thereof includes a plurality of X-sensing series and a plurality of Y-sensing series, wherein the Y-sensing series and the X-sensing series are intersected to each other. Generally speaking, at the intersections of the X-sensing series and the Y-sensing series, the two adjacent touch-sensing pads of one X-sensing series or one Y-sensing series are electronically connected via metal bridging lines. However, in the conventional touch display panels, users can easily see the inner structures such as pixels, etc., and this affects thereby deteriorating the visual quality of the touch display panels. Therefore, the visual quality of the touch display panel is still one of the most importance issues that needs to be improved.

### SUMMARY OF THE INVENTION

The present invention is further directed to a touch display panel with better visual effect.

The present invention provides a touch display panel including a display panel and a touch panel. The display panel includes a shielding pattern and a plurality of pixels separated by the shielding pattern and including multiple edge directions. The touch panel is disposed on the display panel and includes a plurality of first sensing series, a plurality of second sensing series and a plurality of dielectric patterns. Each dielectric pattern is disposed between each first sensing series and each second sensing series intersected therewith, and includes multiple edge directions non-parallel to the edge directions of the pixel.

According to an embodiment of the present invention, the edge directions of each dielectric pattern are not orthogonal to the edge directions of each pixel.

According to an embodiment of the present invention, the dielectric patterns are rectangular, and the included angle between the four edge directions of the rectangular dielectric patterns and the edge directions of the pixels are not 0 degree or 90 degrees.

According to an embodiment of the present invention, the included angles between the four edge directions of the rectangular dielectric patterns and the edge directions of the pixels are between 0 degree to 80 degrees.

According to an embodiment of the present invention, the included angles between the four edge directions of the rectangular dielectric patterns and the edge directions of the pixels are 45 degrees.

According to an embodiment of the present invention, the rectangular dielectric patterns includes multiple diagonal lines overlapped to the shielding pattern.

According to an embodiment of the present invention, each dielectric pattern includes an upper surface in the form of the convex and distant from the pixels.

According to an embodiment of the present invention, each first sensing series includes a plurality of first sensing pads and a plurality of first connecting lines disposed between two first adjacent sensing pads. Each second sensing series includes a plurality of second sensing pads and a plurality of second connecting lines disposed between two adjacent second sensing pads. Each dielectric pattern is disposed between each first connecting line and each second connecting line intersected therewith.

According to an embodiment of the present invention, the dielectric patterns are made of the organic material.

According to an embodiment of the present invention, the display panel includes liquid crystal display panel, organic electro-luminescent display panel, electrowetting display panel, or electrophoretic display panel.

Based on the description above, in the touch display panel of the present invention, by setting specific included angles between the edge directions of the pixels and the edge directions of the dielectric pattern disposed between the intersected sensing series, the interference between the dielectric patterns and the shielding pattern can be destroyed. The problems such as the inner structures are easily seen due to the shielding pattern of the pixels enlarged by the dielectric patterns are solved. Therefore, the touch display panel can have better visual effect.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1A is a schematic cross-sectional view of the touch display panel of one embodiment of the present invention.

FIG. 1B is a schematic partial view of the arrangement of the pixels and the shielding pattern in the display panel and the arrangements of the sensing series and the dielectric patterns in the touch panel of FIG. 1A.

FIG. 1C is a schematic cross-sectional view taken along a section line B-B′ depicted in FIG. 1B.

FIG. 2A illustrates the touch display panel of one embodiment of the present invention.

FIG. 2B and FIG. 2C are comparative examples of the touch display panel of the present invention.

FIG. 3A is a partial enlarged view of the dielectric patterns arrangement of a comparative example of the present invention, and FIG. 3B is a top view of the touch display panel according to the arrangement of FIG. 3A.

FIG. 4A is a partial enlarged view of the dielectric patterns arrangement of one embodiment of the present invention, and FIG. 4B is a top view of the touch display panel according to the arrangement of FIG. 4A.

### DESCRIPTION OF EMBODIMENTS

The black matrix and the pixels with periodical structures disposed underneath are obviously seen by the user because of the focus effect resulted from the shape of the dielectric pattern similar to that of the convex such that the visual effect of the touch display panel is worse. Therefore, the dielectric patterns of the present invention are properly designed based on the edge directions of the pixels in the display panel to blur the contour between the black matrix and the pixels and enhance the visual effect.

To explain the spirit of the touch display panel of the present invention more clearly, a few embodiments are listed in the following paragraphs for reference, but the present invention is not limited thereto.

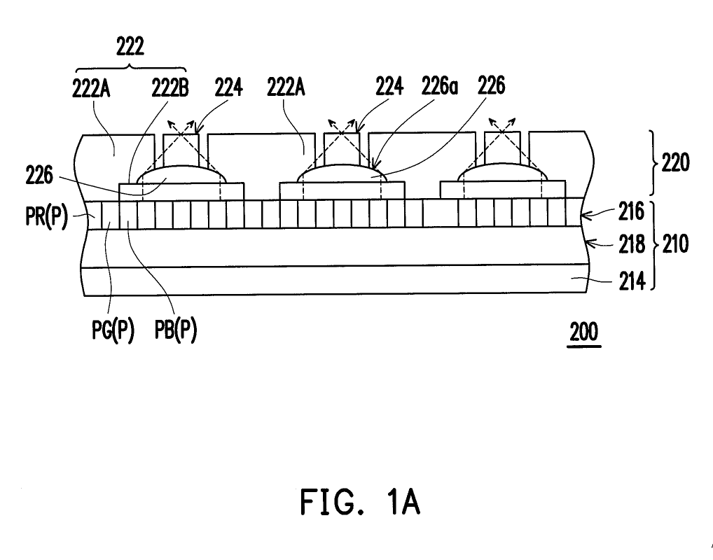

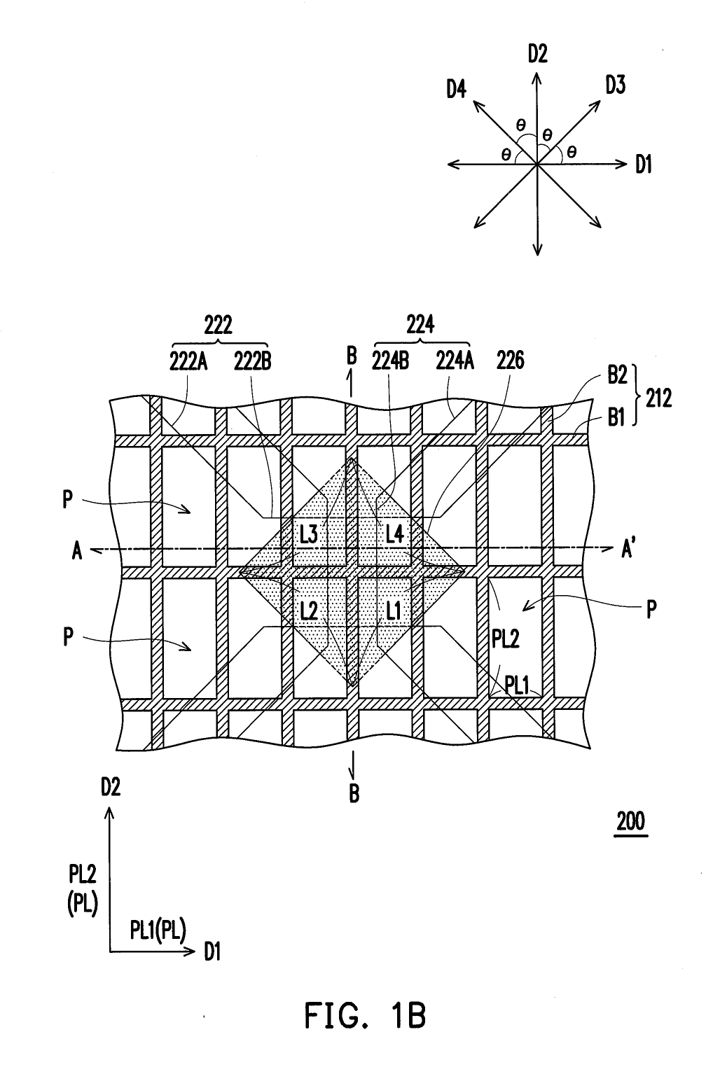

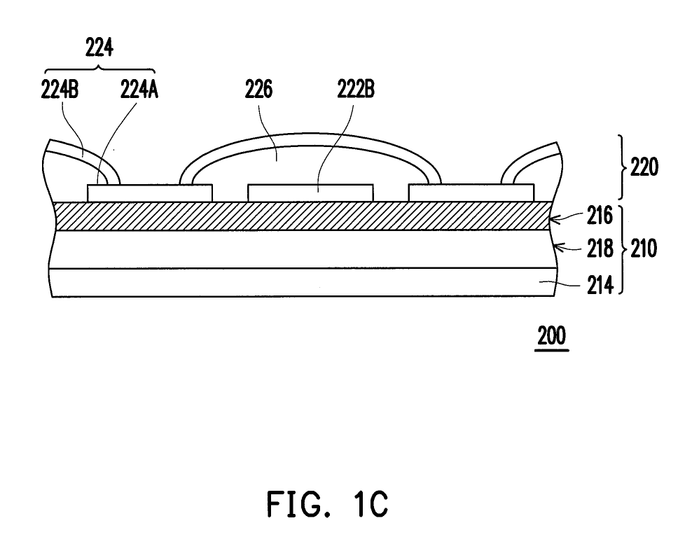

FIG. 1A is a schematic cross-sectional view of the touch display panel of one embodiment of the present invention. FIG. 1B is a schematic partial view of the arrangement of the pixels and the shielding pattern in the display panel and the arrangement of the sensing series and the dielectric patterns in the touch panel of FIG. 1A. FIG. 1A is a cross-sectional view taken along the section line A-A′ depicted in FIG. 1B. FIG. 1C is a cross-sectional view taken along the section line B-B′ depicted in FIG. 1B.

Please refer to both FIG lA and FIG. 1B, the touch display panel 200 includes a display panel 210 and a touch panel 220. The display panel 210 can be a LCD panel. In other embodiments, the display panel also may be an organic electro-luminescent display panel, an electrowetting display panel, or an electrophoretic display panel. The display panel 210 includes a shielding pattern 212 and a plurality of pixels P separated by the shielding pattern 212 wherein each pixel P comprises a plurality of edge directions PL. The display panel 210 of the present embodiment includes a substrate 214, a color filter 216 and an active element array layer 218 disposed therebetween, but the present invention is not limited thereto.

Further in more detail, the shielding pattern 212 of the present embodiment includes a plurality of first shielding stripes B1 extending along a first direction D1, and a plurality of second shielding stripes B2 extending along a second direction D2. The first shielding stripes B1 and the second shielding stripes B2 are intersected to form a meshed shielding pattern 212, and each pixel P disposed in each opening of the shielding pattern 212. In the present embodiment, the material of shielding pattern 212 is, for example, black resin, so the shielding pattern 212 can also be called black matrix. The pixels P of the present embodiment includes a plurality of red pixels PR, a plurality of green pixels PG, and a plurality of blue pixels PB.

As shown in FIG. 1A, FIG. 1B and FIG. 1C, the touch panel 220 is disposed on the display panel 210. The touch panel 220 includes a plurality of first sensing series 222, a plurality of second sensing series 224 and a plurality of dielectric patterns 226. Each dielectric pattern 226 is disposed between each first sensing series 222 and each second sensing series 224 intersected with the first sensing series 222, wherein the dielectric patterns 226 are made of organic materials.

More specifically, in the present embodiment, the first sensing series 222 extend along the first direction D1, and each first sensing series 222 includes a plurality of first sensing pads 222A serially connected with each other and a plurality of first connecting lines 222B disposed between the two adjacent first sensing pads 222A. The second sensing series 224 extend along the second direction D2. Each second sensing series 224 includes a plurality of second sensing pads 224A serially connected with each other, and a plurality of second connecting lines disposed between the two adjacent second sensing pads 224A. Each dielectric pattern 226 is disposed between each first connecting line 222B and each second connecting line 224B intersected with the first connecting line 222B, so that the first sensing series 222 and the second sensing series 224 are electrically insulated from each other. The first sensing pads 222A and the second sensing pads 224A can be disposed on the same or different substrate. In the present embodiment, the first connecting lines 222B and the second connecting lines 224B are disposed respectively underneath and upon the dielectric patterns 226, and the materials of the first connecting lines 222B and the second connecting lines 224B includes transparent conducting materials. Obviously, the positions of first connecting lines 222B and the second connecting lines 224B may be interchanged. The present invention is not limited thereto.

In particular, as shown in FIG. 1B, the edge directions of every dielectric pattern 226 are tilted to the edge directions of the pixels P. It should be noted that, the so called tilted means the edge directions of every dielectric pattern 226 (D3 and D4 as shown) are neither parallel nor orthogonal to the edge directions of the pixels P (D1 and D2 as shown). More specifically, as shown in FIG. 1B, the edge directions, i.e. the extending directions of the edge directions PL, are the extending directions of the first shielding stripes B1 and that of the second shielding stripes B2 of the shielding pattern 212. For example, in this embodiment, the extending direction of the short edge direction PL1 is the first direction D1, and the extending direction of the long edge direction PL2 is the first direction D2.

The dielectric patterns 226 of the present embodiment are, for example, rectangular, and the shielding pattern 212 is disposed right over the diagonal lines of the rectangular dielectric patterns 226. Therefore, the shielding pattern 212 is overlapped to the diagonal lines of the rectangular dielectric patterns 226. The extending directions of the four edges L1˜L4 of the rectangular dielectric pattern 226 are the edge directions wherein the edge direction of the edges L1 and L3 is D3, and the edge direction of the edges L2 and L4. In particular, the included angles between the edge directions D3 and D4 of the rectangular dielectric patterns 226 and the edge directions D1 and D2 of the pixels P are not 0 degree or 90 degrees. As shown in FIG. 1B, the acute included angles between the edge directions D3 and D4 and the edge directions D1 and D2 are 45 degrees.

By making the edge directions D3 and D4 of the dielectric patterns 226 tilted to the edge directions D1 and D2 of the pixels P, the edge contours of the dielectric patterns 226 and the edge contour of the black matrix are not parallel overlapped, thereby mitigating the interference with each other. The contours can be blurred when the acute included angles between the edge directions of D3 and D4 of the rectangular dielectric pattern 226 and the edge directions D1 and D2 of the pixels P are not equal to 0 degree or 90 degrees. Preferably, the acute included angles is between 0 degree to 80 degrees. More preferably, the included angles between the edge directions of D3 and D4 of the rectangular dielectric patterns 226 and the edge directions D1 and D2 of the pixels P are 45 degrees. By means of the above method, the interference between the dielectric patterns 226 and the shielding pattern 212 can be mitigated to solve the visual effect problem.

Moreover, as shown in FIG. 1A and FIG. 1C, the upper surface of each dielectric pattern 226 distant from the pixels comprises a convex 226a curved in one dimension to form a structure similar to a lenticular lens. The dielectric patterns 226 with convex structure have focus effect, so the pixels P, the shielding pattern 212, or the first connecting lines 222B disposed under the dielectric patterns 226 and in focus of the lenticular lens are easily visually enlarged by the dielectric patterns 226. Therefore, the magnified image can be seen by the user to identify the inner structures of the touch display panel such that the quality of the visual effect is decreased. However, by making the edge directions D3 and D4 of each dielectric pattern 226 in the touch display panel 200 of the present invention tilted to the edge directions D1 and D2 of the pixels P, the periodically arranged contours of the pixels P and the shielding pattern 212 can be effectively blurred, thereby enhancing the visual quality for the users and solving the poor visual quality problem caused by the convex effect of the dielectric patterns 226 described above.

For a better illustration of the arrangement of the dielectric patterns and the pixels and the visual effects the users can see, a few figures for analyzing and comparing the embodiments of the visual effects and the arrangement of the dielectric patterns and the pixels are provided to thoroughly and completely disclose the purposes of the touch display panel of the present invention, but the present invention is not limited thereto.

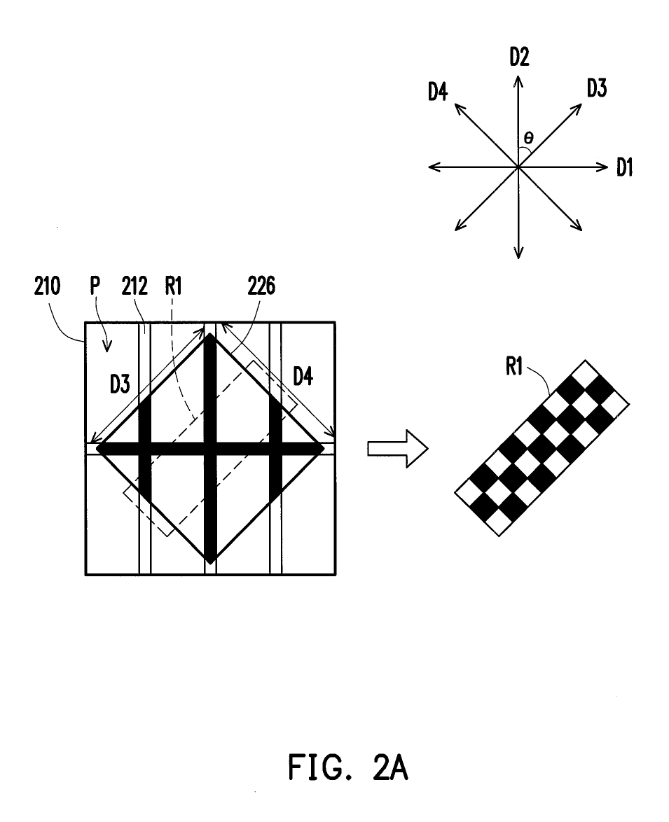

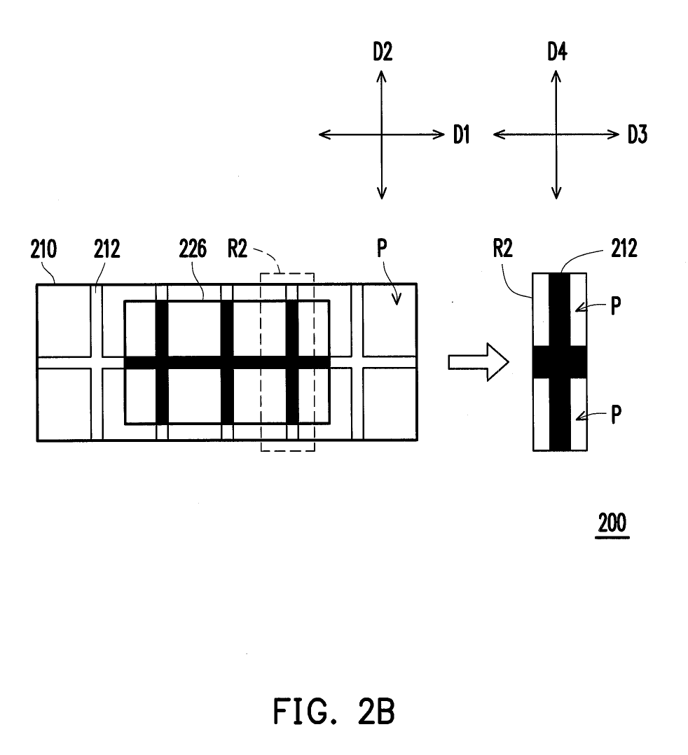

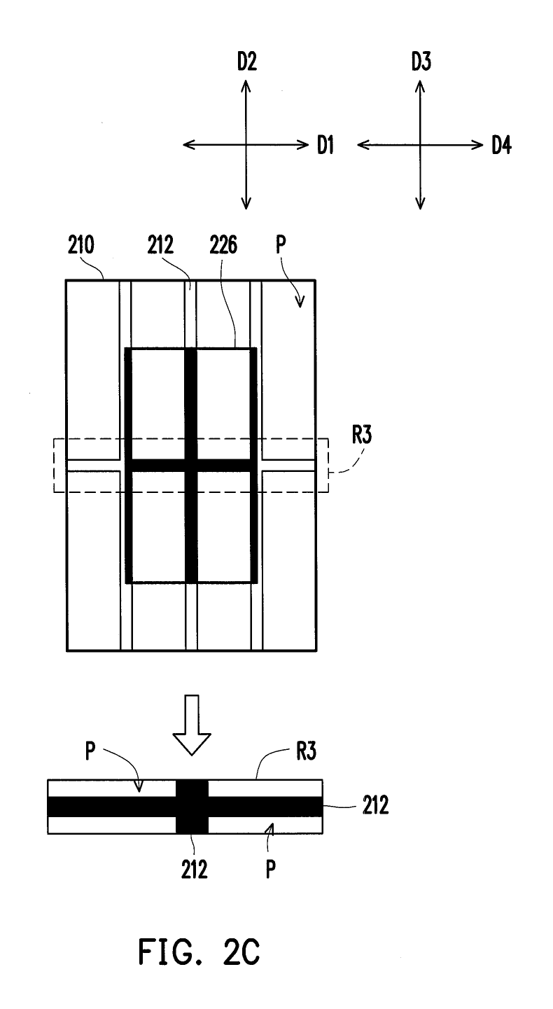

FIG. 2A is one embodiment of the touch display panel of the present invention. FIG. 2B and FIG. 2C are the comparative examples of the touch display panel of the present invention. Please refer to FIG. 2A, when the users look at the region R1 of the touch display panel 200 on the left side of FIG. 2A, by making the edge directions D3 and D4 of the dielectric pattern 226 tilted to the edge directions Dl and D2 of the pixels, for example, 45 degrees, the edges of the dielectric pattern 226 and the edges of the pixels are not parallel overlapped, thereby blurring the contours between the dielectric pattern 226 and the shielding pattern 212 disposed at the edges of the pixels P, which leads to the visual effect as shown on the right side of FIG. 2A. The problem of identifing the pixels P, the shielding pattern 212 or the first connecting lines 222B by the users is thus can be avoided, and the visual quality for the users can also be enhanced.

On the contrary, FIG. 2B shows the situation which the long edge direction D3 of the dielectric pattern 226 is parallel to the edge direction D1 of the pixels. Due to the focus effect similar to the convex of the dielectric pattern 226, when the users look at region R2 of the touch display panel 200 on the left side of FIG. 2B, the shielding pattern 212 and the pixels P are visually enlared by the dielectric pattern 226 to provide the visual effect shown on the right side of FIG. 2B. The contour can not be blurred when the long edge direction D3 of the dielectric pattern 226 is parallel to the edge direction D1 of the pixels. After the sharp contour with high contrast ratio between the pixels P and the shielding pattern 212 is visually enlarged, the contour is more easily seen by the users to identify the pattern such that the visual quality is decreased. Similarly, FIG. 2C shows the situation when the short edge direction D4 of the dielectric pattern 226 is parallel to the edge direction of the pixels D1. When the users look at region R3 of FIG. 2C, similar problem of decreasing the visual effect will also occurs.

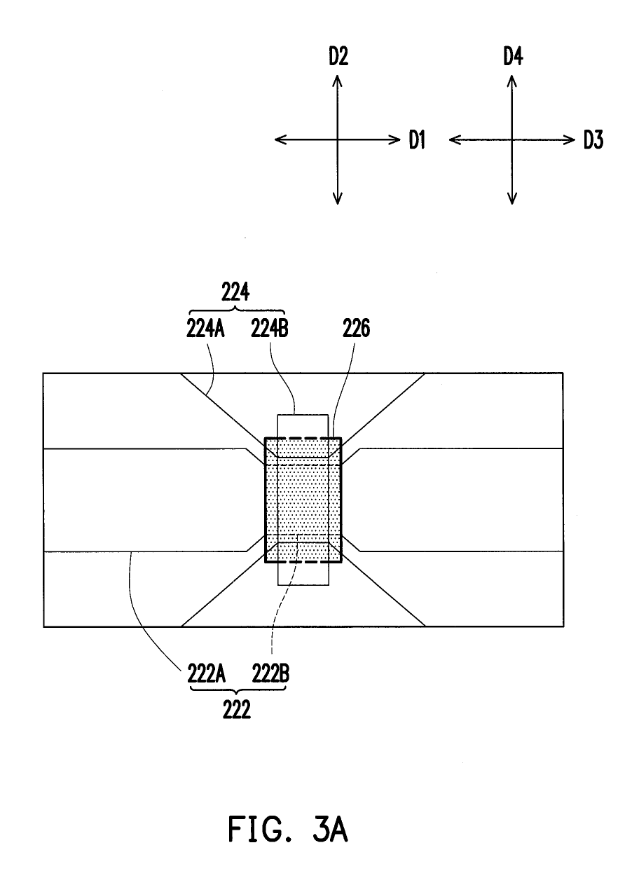

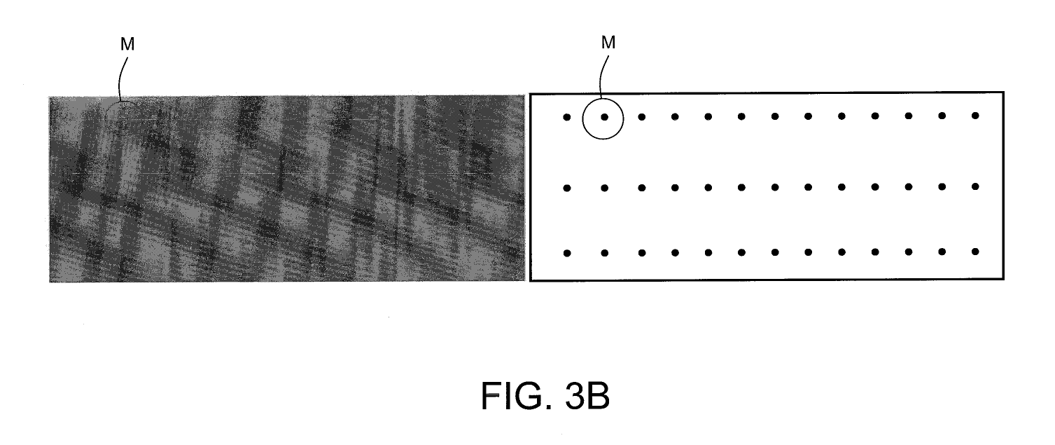

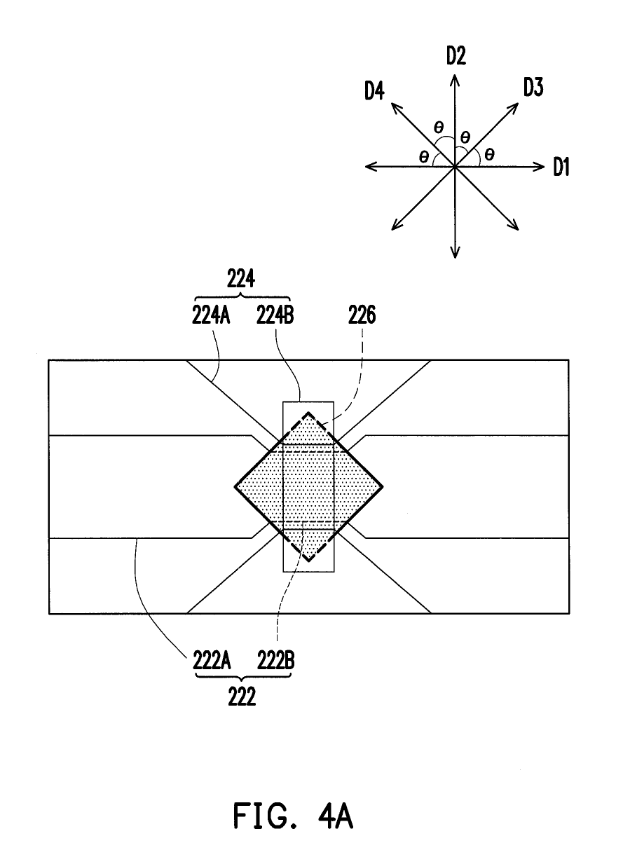

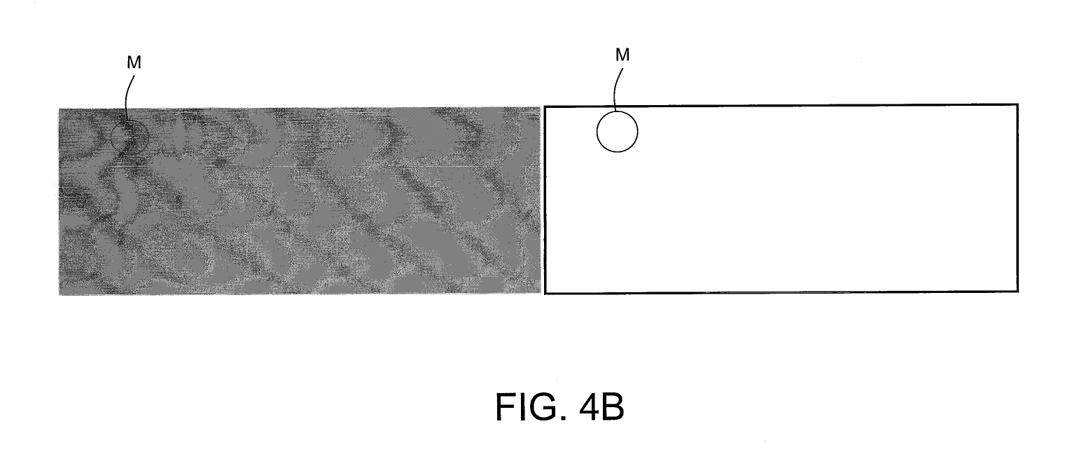

FIG. 3A is a partial enlarged view of the dielectric patterns arrangement as a comparative example of the present invention, and the right side and the left side of FIG. 3B are the visual photo of the touch display panel and the illustrating figure thereof according to the arrangement of FIG. 3A. On the other hand, FIG. 4A is a partial enlarged view of the dielectric patterns arrangement as a comparative example of the present invention, and the right side and the left side of FIG. 4B are the visual photo of the touch display panel and the illustrating figure thereof according to the arrangement of FIG. 4A.

Please refer to FIG. 3A, FIG. 3B, FIG. 4A and FIG. 4B, when the edge directions D3 and D4 of the dielectric pattern 226 are parallel to the edge directions D1 and D2 of the pixels P, as shown in FIG. 3A, the region M of the top view of FIG. 3B can be clearly identified an unexpected pattern as a white dot configured periodically. On the other hand, when the edge directions D3 and D4 are tilted to the edge directions D1 and D2 of the pixels and are not parallel or orthogonal to each other, as shown in FIG. 4A, the unexpected patterns which are clearly seen in FIG. 3B are obscured and can not be identified in region M of FIG. 4B which is the same position of FIG. 3B. Comparing to the comparative example of FIG. 3B, the touch display panel 200 of the present embodiment as shown in FIG. 4B has better visual quality.

In summary, the touch display panel of the present invention comprises specific included angles between the edge directions of the dielectric patterns and the pixels, so the contours between the pixels, the shielding pattern and the dielectric patterns can be blurred and the interference between the dielectric patterns and the shielding pattern can be minimized. Therefore, the problem of the pixels easily identified can be solved, and the visual effect of the touch display panel can be improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A touch display panel, comprising:
a display panel including a shielding pattern and a plurality of pixels separated by the shielding pattern and including multiple edge directions; and
a touch panel disposed on the display panel and including a plurality of first sensing series, a plurality of second sensing series and a plurality of dielectric patterns wherein each dielectric pattern is disposed between each first sensing series and each second sensing series intersected therewith, and includes multiple edge directions non-parallel to the edge directions of the pixel.

2. The touch display panel as claimed in claim 1, wherein the edge directions of each dielectric pattern are not orthogonal to the edge directions of each pixel.

3. The touch display panel as claimed in claim 1, wherein the dielectric patterns are rectangular, and the included angles between the four edge directions of the rectangular dielectric patterns and the edge directions of the pixels are not 0 degree or 90 degrees.

4. The touch display panel as claimed in claim 3, wherein the included angles between the four edge directions of the rectangular dielectric patterns and the edge directions of the pixels are between 0 degree to 80 degrees.

5. The touch display panel as claimed in claim 3, wherein the included angles between the four edge directions of the rectangular dielectric patterns and the edge directions of the pixels are 45 degrees.

6. The touch display panel as claimed in claim 5, wherein the rectangular dielectric patterns includes multiple diagonal lines overlapped to the shielding pattern.

7. The touch display panel as claimed in claim 1, wherein each dielectric pattern includes an upper surface in the form of the convex and distant from the pixels.

8. The touch display panel as claimed in claim 1, wherein each first sensing series includes a plurality of first sensing pads and a plurality of first connecting lines disposed between the two adjacent first sensing pads, each second sensing series includes a plurality of second sensing pads and a plurality of second connecting lines disposed between the two adjacent second sensing pads, and each dielectric pattern is disposed between each first connecting line and each second connecting line intersected therewith.

9. The touch display panel as claimed in claim 1, wherein the dielectric patterns are made of the organic material.

10. The touch display panel as claimed in claim 1, wherein the display panel includes liquid crystal display panel, organic electro-luminescent display panel, electrowetting display panel, or electrophoretic display panel.
